(19) United States
(12) Patent Application Publication
(10) Pub. No.: US 2024/0122178 A1
(43) Pub. Date: Apr. 18, 2024

(54) CAFFEIC ACID-BASED COMPOSITE MATERIAL AND PREPARATION METHOD THEREOF

(71) Applicant: ZHEJIANG UNIVERSITY, Zhejiang (CN)

(72) Inventors: Tian DING, Zhejiang (CN); Mofei SHEN, Zhejiang (CN); Jinsong FENG, Zhejiang (CN); Donghong LIU, Zhejiang (CN); Shiguo CHEN, Zhejiang (CN); Enbo XU, Zhejiang (CN); Wenjun WANG, Zhejiang (CN); Huan CHENG, Zhejiang (CN)

(21) Appl. No.: 18/277,559

(22) PCT Filed: Mar. 11, 2022
(86) PCT No.: PCT/CN22/80304

§ 371 Date: Aug. 16, 2023

(30) Foreign Application Priority Data
Nov. 10, 2021 (CN) 202111328172.8

(51) Int. Cl. A01N 37/38; A01N 25/10; A01P 1/00

(52) U.S. Cl. CPC A01N 37/38; A01N 25/10; A01P 1/00

(57) ABSTRACT

Disclosed are a caffeic acid-based composite material and a preparation method thereof. The method includes: exposing a cyclodextrin metal-organic framework material prepared from γ-cyclodextrin to a solution of caffeic acid in a short-chain alcohol to obtain a mixed material; and incubating the mixed material, wherein during the incubating, the cyclodextrin metal-organic framework material is in dynamic contact with the solution of caffeic acid in a short-chain alcohol. The prepared composite material includes a cyclodextrin metal-organic framework material and caffeic acid loaded on the cyclodextrin metal-organic framework material, wherein the cyclodextrin metal-organic framework material is prepared from γ-cyclodextrin. The caffeic acid is loaded in an amount of 15-18% of a total mass of the caffeic acid-based composite material. The caffeic acid is located in a cavity of the cyclodextrin metal-organic framework material.

The present application claims priority of Chinese Patent Application No. 202111328172.8, filed with the China National Intellectual Property Administration on Nov. 10, 2021, entitled “Caffeic acid-based composite material and preparation method thereof”, the entire disclosure of which is incorporated herein by reference.

### TECHNICAL FIELD

The disclosure relates to the technical field of antibacterial materials, and particularly relates to a caffeic acid-based composite material and a preparation method thereof.

### BACKGROUND

Metal-Organic Frameworks (MOFs) are porous coordination materials composed of multidentate organic ligands and metal ions or metal clusters, and are infinite network structures formed by coordination bonds or covalent bonds between the metal ions center and organic ligands. Metal-Organic Frameworks have the advantages of large specific surface area, adjustable function, high porosity and so on, and are rapidly developing new porous materials with broad prospects.

Cyclodextrin is a naturally occurring cyclic oligosaccharide, which is produced by cyclodextrin glycosyltransferase during the enzymatic degradation of starch. Cyclodextrins usually contain 6-12 D-glucopyranose units, among which molecules containing 6, 7 and 8 glucose units are of great practical significance, which are called α-, β- and γ—cyclodextrin respectively. Cyclodextrin metal-organic frameworks means a formation of a new metal-organic framework from cyclodextrin and alkali metal ions through organic coordination. Compared with the traditional metal-organic frameworks, the new metal-organic frameworks have good water solubility and non-toxicity, and have the characteristics of porosity and large specific surface area. The huge cavity of the new metal-organic frameworks could play a protective role. At present, the new metal-organic frameworks as a delivery material have become a research hotspot.

Caffeic acid is an organic acid that exists in many kinds of foods. Besides food, caffeic acid also exists in common health care drugs such as propolis, which has good biological efficacy such as antioxidation and antibacterial. However, the poor chemical and physical stability of caffeic acid and its derivatives limits its use. There is an urgent need in the field to develop materials and methods to improve the stability of caffeic acid.

### SUMMARY

In view of this, it is an object of the present disclosure to provide a caffeic acid-based composite material and a preparation method thereof, which could solve the problem that materials and methods for improving the stability of caffeic acid are urgently needed in the prior art.

In order to achieve the object of the above disclosure, the present disclosure provides the following technical solutions:

Provided is a method for preparing a caffeic acid-based composite material, comprising the following steps:

exposing a cyclodextrin metal-organic framework (CD-MOF) material prepared from γ-cyclodextrin to a solution of caffeic acid in a short-chain alcohol to obtain a mixed material; and incubating the mixed material; wherein during the incubating, the cyclodextrin metal-organic framework material is in dynamic contact with the solution of caffeic acid in the short-chain alcohol.

In some embodiments, a ratio of the cyclodextrin metal-organic framework material to the solution of caffeic acid in the short-chain alcohol is in a range of 1: 25-70, in terms of a molar ratio of γ-cyclodextrin in the cyclodextrin metal-organic framework material to caffeic acid.

In some embodiments, the incubating is performed for 500-1000 minutes.

In some embodiments, the incubating is performed at a temperature of 30-60° C.

In some embodiments, the ratio of the cyclodextrin metal-organic framework material to the solution of caffeic acid in the short-chain alcohol is in a range of 1: 60-70, in terms of a molar ratio of γ-cyclodextrin in the cyclodextrin metal-organic framework material to caffeic acid; the incubating is performed for 850-950 minutes; and the incubating is performed at a temperature of 35-45° C.

In some embodiments, the ratio of the cyclodextrin metal-organic framework material to the solution of caffeic acid in the short-chain alcohol is 1:64, in terms of a molar ratio of γ-cyclodextrin in the cyclodextrin metal-organic framework material to caffeic acid; the incubating is performed for 900 minutes; and the incubating is performed at a temperature of 40° C.

In some embodiments, the cyclodextrin metal-organic framework material is prepared by a process comprising the following steps:

ultrasonically mixing an aqueous solution containing both of γ-cyclodextrin and potassium hydroxide dispersed therein, placing the aqueous solution in a water bath, and subjecting the aqueous solution to a water bath reaction to obtain a reaction solution, after the water bath reaction, subjecting the reaction solution to an ultrasonic treatment, and simultaneously adding polyethylene glycol therein during the ultrasonic treatment to obtain a crude product; and washing and drying the crude product to obtain the cyclodextrin metal-organic framework material.

In some embodiments, a molar ratio of γ-cyclodextrin to potassium hydroxide in the aqueous solution is in a range of 1: 5-10. Usually, potassium ions in CD-MOF are in a form of 8 coordination, which could make six γ-cyclodextrins form a smallest building block of CD-MOF, which is equivalent to two potassium ions paired with one γ-cyclodextrine, with a chemical formula of [(C₄₈H₈₀O₄₀)(KOH)₂]ₙ. In some embodiments, excessive potassium hydroxide is beneficial to participation of all γ-cyclodextrins in the reaction.

In some embodiments, the polyethylene glycol has a molecular weight of 8000, and a molar ratio of the polyethylene glycol added to γ-cyclodextrin is in a range of 0.06-0.07:1.

In some embodiments, the water bath reaction is performed at a temperature of 55-65° C.

In some embodiments, the short-chain alcohol is anhydrous methanol or anhydrous ethanol. The short-chain alcohol is used as a solvent which is suitable to fully dissolve reactants.

The dynamic contact means that during the reaction process, the cyclodextrin metal-organic framework material and caffeic acid are in a dynamic process, not in a static state, for example, by stirring, or by oscillation.

In some embodiments, the dynamic contact is achieved by stirring or oscillation; and a rotating speed for the stirring or oscillation is in a range of 100 rpm to 400 rpm.

In some embodiments, the method further includes a post-treatment after the incubating. The post-treatment includes: centrifuging a mixture obtained from the incubating, discarding the supernatant, and drying in vacuum.

In some embodiments, the drying in vacuum is performed at a temperature of 40-60° C. for 4-6 hours.

Also provided is a caffeic acid-based composite material prepared by the method above. In the disclosure, the caffeic acid-based composite material includes a cyclodextrin metal-organic framework material and caffeic acid loaded on the cyclodextrin metal-organic framework material, wherein the cyclodextrin metal-organic framework material is prepared from γ-cyclodextrin; the caffeic acid is loaded in an amount of 15-18% of the total mass of the caffeic acid-based composite material; and caffeic acid is located in a cavity of the cyclodextrin metal-organic framework material.

The disclosure provides a caffeic acid derivative-based composite material, which includes a cyclodextrin metal-organic framework material and a caffeic acid derivative loaded on the cyclodextrin metal-organic framework material, wherein the cyclodextrin metal-organic framework material is prepared from γ-cyclodextrin; and the caffeic acid derivative is located in a cavity of the cyclodextrin metal-organic framework material.

Compared with the prior art, the embodiments of the present disclosure have the following beneficial effects:

In the disclosure, the method of loading caffeic acid by using the cyclodextrin metal-organic framework material is simple in operation and mild in reaction, and a higher caffeic acid loading rate is also realized. The cyclodextrin metal-organic framework material loaded with caffeic acid prepared by the method has a relatively uniform particle size, obvious XRD diffraction peaks, good crystal characteristics, good thermal stability and chemical stability, and could be applied to application research in the fields of food, environment and the like.

### BRIEF DESCRIPTION OF THE DRAWINGS

FIG. 1 is a diagram showing the effect of a molar ratio of γ-cyclodextrin to caffeic acid in the cyclodextrin metal-organic framework composite according to embodiments of the present disclosure on the caffeic acid loading rate.

FIG. 2 is a diagram showing the effect of incubating time of the cyclodextrin metal-organic framework and caffeic acid on the caffeic acid loading rate.

FIG. 3 is a diagram showing the effect of incubating temperature of the cyclodextrin metal-organic framework composite and caffeic acid on the caffeic acid loading rate.

FIG. 4 is a diagram showing powder X-ray diffraction (XRD) pattern of the cyclodextrin metal-organic framework composite loaded with caffeic acid as prepared in Example 1.

FIG. 5 is a scanning electron microscope image of the cyclodextrin metal-organic framework composite loaded with caffeic acid as prepared in Example 1.

FIG. 6 is a diagram showing infrared spectrum of the cyclodextrin metal-organic framework composite loaded with caffeic acid as prepared in Example 1.

FIG. 7 is a diagram showing thermogram of the cyclodextrin metal-organic framework composite loaded with caffeic acid as prepared in Example 1.

FIG. 8 is a diagram showing the comparison of the caffeic acid loading rate between the cyclodextrin metal-organic framework and equimolar γ-cyclodextrin.

### DETAILED DESCRIPTION OF THE EMBODIMENTS

The technical solution of the disclosure will be described clearly and completely with embodiments. Obviously, the described embodiments are only part of the disclosure, not all. Based on the embodiments of the disclosure, all other embodiments obtained by those skilled in the art without creative work fall within the scope of the disclosure.

Unless otherwise defined, all technical and scientific terms used herein have the same meaning as commonly understood by those skilled in the art in the field of the disclosure. The term used herein in the specification of the disclosure is only for the purpose of describing specific embodiments, and is not intended to limit the disclosure.

The disclosure found that the problem of poor chemical and physical stability of caffeic acid and its derivatives can be solved by using a cyclodextrin metal-organic framework material to load caffeic acid:adding a cyclodextrin metal-organic framework material to a solution of caffeic acid in a short-chain alcohol, and incubating a resulting mixed material while stirring at a certain rotating speed, so as to obtain a cyclodextrin metal-organic framework composite material loaded with caffeic acid.

In one embodiment, under the conditions of reaction temperature of 40° C. and reaction time of 900 minutes, the effects of different ratios of the cyclodextrin metal-organic framework material to caffeic acid (a molar ratio of γ-cyclodextrin in the cyclodextrin metal-organic framework material to caffeic acid is 1:4, 1:8, 1:32, 1:64 and 1:128, respectively) on the caffeic acid loading rate are compared. The results are shown in FIG. 1. From the results, it can be seen that when the molar ratio of γ-cyclodextrin to caffeic acid in the cyclodextrin metal-organic framework composite is 1:4, the caffeic acid loading rate exceeds 10%; with the increase of caffeic acid dosage, the caffeic acid loading rate gradually increases, and the increase of the loading rate is no longer obvious after increasing to 1:64. Therefore, the molar ratio of γ-cyclodextrin in the cyclodextrin metal-organic framework material to caffeic acid is selected from 1:4 to 1:128, further from 1:32 to 1:128, further from 1:25 to 1:70, still further from 1: 60-70, and most preferably is 1:64.

The smallest building block of CD-MOF has a chemical formula of [(C₄₈H₈₀O₄₀)(KOH)₂]₆, and thus the relative molecular weight of CD-MOF can be approximately regarded as 8112, wherein one molecular of CD-MOF contains 6γ-cyclodextrin molecules, that is, one mol of CD-MOF contains 6 mol of γ-cyclodextrin.

The cyclodextrin metal-organic framework with a body-centered cubic structure is formed by γ-cyclodextrin and metal ions, and a composite is formed by the cyclodextrin metal-organic framework and caffeic acid, in which the cyclodextrin metal-organic framework does not destroy the structure of γ-cyclodextrin, and it can also be understood that all γ-cyclodextrin is used to form the cyclodextrin metal-organic framework under the condition of excessive metal ions. Therefore, in the actual experimental process, the molar ratio of the cyclodextrin metal-organic framework material to caffeic acid can also be calculated according to a molar ratio of γ-cyclodextrin used to prepared the cyclodextrin metal-organic framework material to caffeic acid.

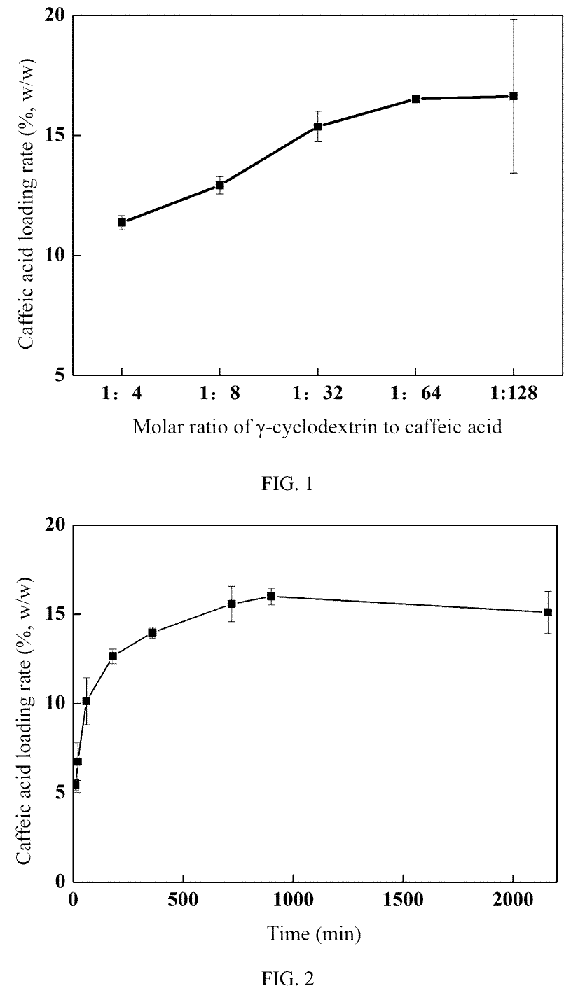

In one embodiment, the effects of different incubating time (10, 20, 60, 180, 360, 720, 900, 2160 minutes) on the caffeic acid loading rate are compared under the conditions: the molar ratio of γ-cyclodextrin in the cyclodextrin metal-organic framework material to caffeic acid being 1:64 and the reaction temperature being 40° C. The results are shown in FIG. 2. As shown in FIG. 2, the loading amount of caffeic acid gradually increases with the prolongation of time, and does not increase until a certain extent. Therefore, the incubating time of the cyclodextrin metal-organic framework and caffeic acid is selected from 500 minutes to 1000 minutes.

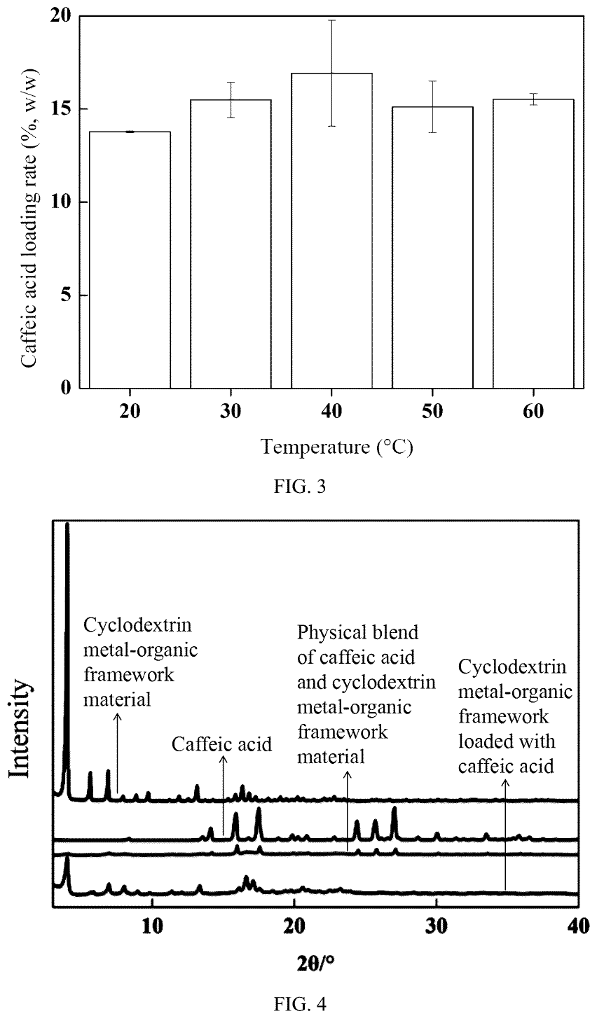

In one embodiment, the effects of different temperatures (20° C., 30° C., 40° C., 50° C. and 60° C.) on the caffeic acid loading rate are compared under the conditions: the molar ratio of γ-cyclodextrin in the cyclodextrin metal-organic framework material to caffeic acid being 1:64 and a reaction time being 900 minutes. As shown in FIG. 3, a γ-acid loading rate could reach 15% within a temperature range of 30° C. to 60° C. Thus, in some embodiments, the reaction temperature is 30° C. to 60° C., preferably 35° C. to 45° C., and more preferably 40° C.

The content (w/w) of caffeic acid in the composite prepared by the disclosure is no less than 5%, preferably no less than 10%, and more preferably no less than 15%.

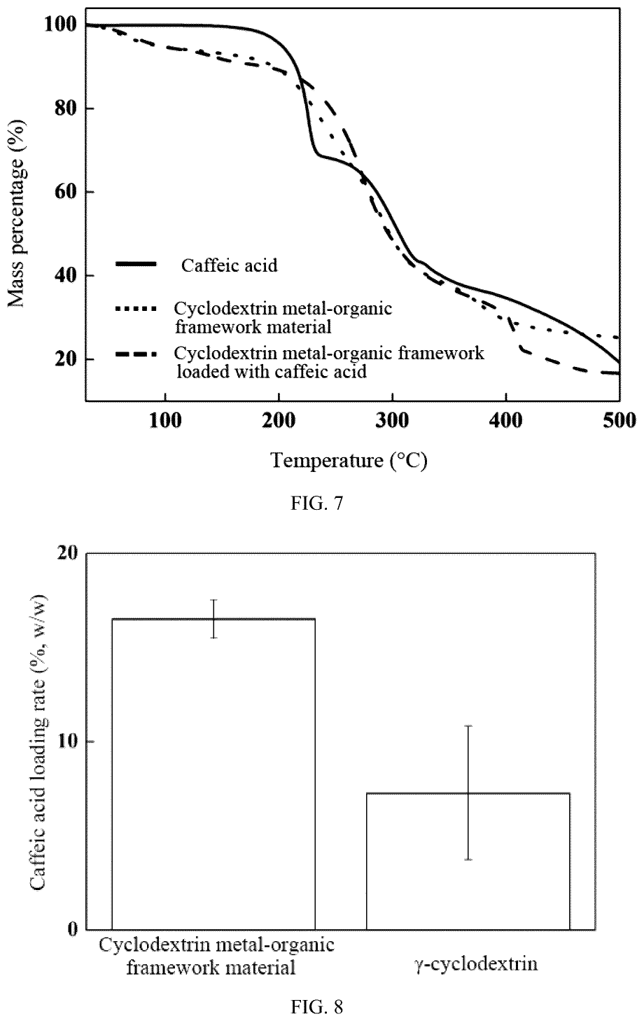

The thermal stability and chemical stability of the caffeic acid-based composite material in the disclosure are significantly improved. When at a decomposition temperature of caffeic acid of 230° C., the thermogravimetric loss of caffeic acid in the composite material is reduced by 13% than that of free caffeic acid, as shown in FIG. 7.

Under the optimum reaction conditions (the ratio of γ-cyclodextrin to caffeic acid in the cyclodextrin metal-organic framework composite is 1:64, the loading time is 900 minutes, and the loading temperature is 40° C.), the caffeic acid loading rate in the prepared composite is 2.3 times higher than that of equimolar γ-cyclodextrin, as shown in FIG. 8.

The disclosure also found through experiments that under the optimal loading conditions (the molar ratio of γ-cyclodextrin to caffeic acid in the cyclodextrin metal-organic framework composite is 1:64, the loading time is 900 minutes, and the loading temperature is 40° C.), the caffeic acid loading rate of the cyclodextrin metal-organic framework can reach 16.52%, which is higher than that of equimolar γ-cyclodextrin (7.28%).

The following is an example of the optimal reaction conditions:

### Example 1

(1) γ-cyclodextrin (648 mg, 0.5 mmol), potassium hydroxide (256 mg, 4.56 mmol) and ultrapure water (20 mL) were added into a beaker, stirred at ambient temperature, and filtered with 0.45 μm aqueous filter membrane, obtaining a solution 1.

(2) Methanol (12 mL) was placed in an ultrasonic tube in advance, and then the solution 1 was placed in the ultrasonic tube to form a milky white solution 2. The ultrasonic tube was placed in a water bath with a temperature of 60° C. and allowed to stand for 15 minutes, obtaining a clear and transparent solution 3.

(3) The solution 3 was subjected to an ultrasonic treatment, and polyethylene glycol (8000) (256 mg) was quickly added thereto when the ultrasonic treatment was started, and reacted, obtaining a crude product.

(4) The crude product was transferred from the ultrasonic tube to a beaker, stood for 1 hour. A resulting precipitate was centrifugally washed with methanol for three times, and then dispersed in methanol after centrifugal separation.

(5) A product obtained from the centrifugal separation was put into a vacuum drying box, dried at 50° C. under vacuum condition for 12 hours, and cooled to ambient temperature, obtaining a cyclodextrin metal-organic framework material.

(6) 50 mg of the cyclodextrin metal-organic framework material was placed in 53.25 mL of a solution of caffeic acid in ethanol with a caffeic acid concentration of 8 mg/mL (a molar ratio of γ-cyclodextrin in the cyclodextrin metal-organic framework material to caffeic acid was 1:64), and a resulting mixture was stirred at 40° C. by magnetic stirring at a rotation speed of 180 rpm, and incubated for a continuous 15 hours, during which it was kept in a dark state.

(7) The resulting solution after incubation was centrifuged at 5000 rpm, a supernatant was discarded, and a residual solvent was absorbed by a filter paper. A resulting precipitate was dried in vacuum at 50° C. for 5 hours, obtaining a caffeic acid-loaded cyclodextrin metal-organic framework composite.

The powder X-ray diffraction pattern of the caffeic acid-loaded cyclodextrin metal-organic framework composite material synthesized in the example is shown in FIG. 4. From FIG. 4, it can be seen that the peak positions in the XRD pattern of the caffeic acid-loaded cyclodextrin metal-organic framework composite material prepared in the example are consistent with those of the cyclodextrin metal-organic framework material, which shows that loading caffeic acid does not destroy the structure of the cyclodextrin metal-organic framework material. Compared with XRD patterns of caffeic acid and a physical blend of caffeic acid and the cyclodextrin metal-organic framework material, characteristic peaks of caffeic acid disappear, which shows that caffeic acid is in a cavity of the cyclodextrin metal-organic framework material.

The infrared spectrum of the caffeic acid-loaded cyclodextrin metal-organic framework composite material synthesized in the example is shown in FIG. 6. The peak positions in the infrared spectrum of the caffeic acid-loaded cyclodextrin metal-organic framework composite material prepared in the example are consistent with those of the cyclodextrin metal-organic framework material, which shows that loading caffeic acid does not destroy the structure of the cyclodextrin metal-organic framework material. Compared the infrared spectra of caffeic acid and the physical blend of caffeic acid and the cyclodextrin metal-organic framework material, the characteristic peaks of caffeic acid are weakened or even partially disappeared, indicating that caffeic acid is in a cavity of the cyclodextrin metal-organic framework material. In the example, the product with the target structure was obtained.

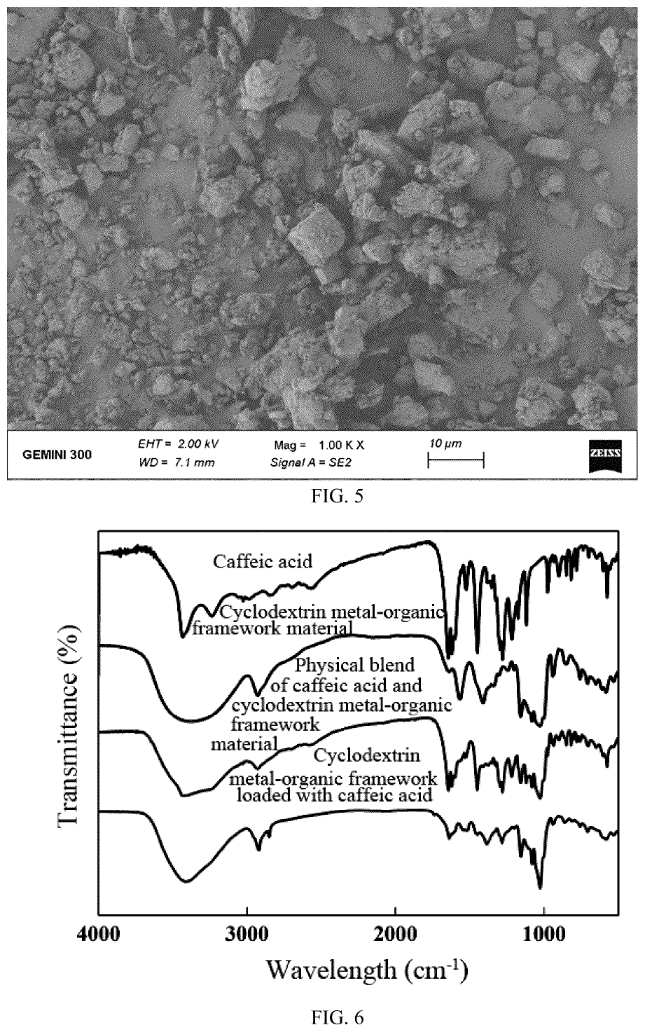

The morphology of the cyclodextrin metal-organic framework synthesized in the example is shown in FIG. 5, showing a certain regular geometric shape.

The description of the above embodiments is only for helping to understand the method of the present disclosure and its core concept. It should be pointed out that for those skilled in the art, without departing from the principle of the disclosure, several improvements and modifications to the disclosure could be made, and these improvements and modifications also fall within the scope of the claims of the disclosure. Many modifications to these embodiments will be obvious to those skilled in the art, and the general principles defined herein could be implemented in other embodiments without departing from the spirit or scope of the disclosure. Therefore, the present disclosure is not to be limited to the embodiments shown herein, but is to be accorded the widest scope consistent with the principles and novel features disclosed herein.

1. A method for preparing a caffeic acid-based composite material, comprising:
exposing a cyclodextrin metal-organic framework material prepared from γ-cyclodextrin to a solution of caffeic acid in a short-chain alcohol, to obtain a mixed material; and
incubating the mixed material;
wherein during the incubating, the cyclodextrin metal-organic framework material is in dynamic contact with the solution of caffeic acid in the short-chain alcohol.

2. The method of claim 1, wherein a ratio of the cyclodextrin metal-organic framework material to the solution of caffeic acid in the short-chain alcohol is in a range of 1: 25-70, in terms of a molar ratio of γ-cyclodextrin in the cyclodextrin metal-organic framework material to caffeic acid.

3. The method of claim 1, wherein the incubating is performed for 500-1000 minutes.

4. The method of claim 1, wherein the incubating is performed at a temperature of 30-60° C.

5. The method of claim 1, wherein the cyclodextrin metal-organic framework material is prepared by a process comprising the following steps:
ultrasonically mixing an aqueous solution containing both of γ-cyclodextrin and potassium hydroxide dispersed therein,
placing the aqueous solution in a water bath, and subjecting the aqueous solution to a water bath reaction to obtain a reaction solution,
subjecting the reaction solution to an ultrasonic treatment, and simultaneously adding polyethylene glycol thereto during the ultrasonic treatment to obtain a crude product; and
washing and drying the crude product to obtain the cyclodextrin metal-organic framework material;
wherein a molar ratio of the γ-cyclodextrin to the potassium hydroxide in the aqueous solution is in a range of 1:(5-10);
the polyethylene glycol has a molecular weight of 8000, and a molar ratio of the polyethylene glycol added to the γ-cyclodextrin is in a range of (0.06-0.07): 1; and
the water bath reaction is performed at a temperature of 55-65° C.

6. The method of claim 1, wherein the short-chain alcohol is anhydrous methanol or anhydrous ethanol.

7. The method of claim 1, wherein the dynamic contact is achieved by stirring or oscillation, the stirring or oscillation being performed at a rotating speed of 100 rpm to 400 rpm.

8. The method of claim 1, further comprising a post-treatment after the incubating, wherein the post-treatment comprises: centrifuging a mixture obtained from the incubating, discarding a supernatant, and drying in vacuum.

9. The method of claim 8, wherein the drying in vacuum is performed at a temperature of 40-60° C. for 4-6 hours.

10. The method of claim 1, wherein a smallest building block of the cyclodextrin metal-organic framework material has a chemical formula of [(C₄₈H₈₀O₄₀)(KOH)₂]ₙ; and
one molecular of the cyclodextrin metal-organic framework material contains 6γ-cyclodextrin molecules.

11. A caffeic acid-based composite material prepared by the method of claim 1.

12. The caffeic acid-based composite material of claim 11, wherein the caffeic acid-based composite material comprises a cyclodextrin metal-organic framework material and caffeic acid loaded on the cyclodextrin metal-organic framework material;
wherein the cyclodextrin metal-organic framework material is prepared from γ-cyclodextrin; and
the caffeic acid is located in a cavity of the cyclodextrin metal-organic framework material.

13. The caffeic acid-based composite material of claim 12, wherein in the caffeic acid-based composite material, the caffeic acid is loaded in an amount of 15-18% of a total mass of the caffeic acid-based composite material.

14. A caffeic acid derivative-based composite material, comprising a cyclodextrin metal-organic framework material and a caffeic acid derivative loaded on the cyclodextrin metal-organic framework material;
wherein the cyclodextrin metal-organic framework material is prepared from γ-cyclodextrin; and
the caffeic acid derivative is located in a cavity of the cyclodextrin metal-organic framework material.

15. The method of claim 3, wherein the incubating is performed at a temperature of 30-60° C.

16. The caffeic acid-based composite material of claim 11, wherein a smallest building block of the cyclodextrin metal-organic framework material has a chemical formula of [(C₄₈H₈₀O₄₀)(KOH)₂]ₙ; and
one molecular of the cyclodextrin metal-organic framework material contains 6γ-cyclodextrin molecules.
